(19) United States
(12) Patent Application Publication
(10) Pub. No.: US 2003/0045399 A1
(43) Pub. Date: Mar. 6, 2003

(54) Method and system for shift control of an automatic transmission

(76) Inventor: Sang-Shin Lee, Hwaseong-City (KR)

Correspondence Address: Pennie & Edmonds, LLP, 3300 Hillview Avenue, Palo Alto, CA, 94304, US

(21) Appl. No.: 10/231,591

(22) Filed: Aug. 30, 2002

(30) Foreign Application Priority Data
Aug. 31, 2001 (KR) 2001-0053470

(51) Int. Cl. F16H 61/00; F16H 59/48

(52) U.S. Cl. 477/118; 477/120

(57) ABSTRACT

A shift control system and a method thereof for an automatic transmission of a vehicle are provided. A shift range assembly permits selection of a specific shift range of automatic shift mode ranges and manual shift mode ranges. The automatic shift mode ranges include a park range, a reverse range, a neutral range, a drive range, and an engine-brake range. A shift lever position sensor detects the specific shift range selected by the shift lever assembly and outputs a corresponding signal. A shift controller outputs a shift signal for down-shifting from a current shift speed to a shift speed lower by 1 shift speed, if the detected specific shift range is the engine-brake range.

### FIELD OF THE INVENTION

The present invention relates to an automatic transmission, and more particularly, to a shift control method for an automatic transmission and a system thereof.

### BACKGROUND OF THE INVENTION

Generally, as shown in FIG. 1, in an automatic transmission having an automatic shift mode and a manual shift mode(sports mode), the automatic shift mode and the manual shift mode are respectively disposed to the left and right sides of a stationary base member of a shift lever assembly. The automatic shift mode comprises a park P range, a reverse R range, a neutral N range, and a drive D range, and the manual shift mode comprises a manual shift-up (+) range and a manual shift-down (−) range.

In the manual shift mode, a shift lever 110 is permitted to be moved in order to manually shift the automatic transmission up and down.

In the above-stated transmission, the engine can be used for braking in all vehicle speed ranges. However, with this configuration, a driver must move the shift lever 110 in the rightward direction and then in the downward direction in order to use the engine for braking. Further, a counter operation of the shift lever 110 is needed for moving the shift lever to the automatic shift mode.

That is, because an over-drive on/off button has been eliminated in the above type of transmission, a driver must move the shift lever 110 in the rightward direction and then in the downward direction, and move the shift lever 110 in the leftward direction in order to use the engine for braking. Therefore, it is difficult to rapidly use the engine for braking. Furthermore, noise is generated while the shift lever 110 is moved to the rightward or leftward directions.

In a 7-position (P, R, N, D, 3, 2, and L ranges) transmission or an overdrive on/off transmission, downshifting is automatically performed from high speed ranges above fourth speed to a third speed. However, in speed ranges below third speed, a driver must move the shift lever manually for downshifting in order to use the engine for braking.

For the above reason, while driving in the drive D range, a driver generally uses a foot brake instead of using the engine for braking, and frequent or constant use of the foot brake causes a fade phenomenon or a vapor lock phenomenon, so that braking properties diminish. Thus, in general, in the conventional automatic transmission use of the engine for braking is relatively easy. However, in an automatic transmission having the manual shift mode, it is difficult to rapidly use the engine for braking.

### SUMMARY OF THE INVENTION

The present invention provides a shift control system and a method thereof for an automatic transmission having a manual shift mode which facilitates use of the engine for braking by simple manipulation of the shift lever in all forward speed ratios excluding a lowest speed ratio. In a preferred embodiment of the present invention, a shift range assembly is provided for selecting a specific shift range of the automatic shift mode ranges and manual shift mode ranges. The automatic shift mode ranges include a park range, a reverse range, a neutral range, a drive range, and an enginebrake range. A shift lever position sensor detects the specific shift range selected by the shift lever assembly and outputs a corresponding signal. A shift controller outputs a shift signal for down-shifting from a current shift speed to a shift speed lower by 1 shift speed, if the detected specific shift range is in the engine-brake range.

It is preferable that the automatic shift mode ranges have an arrangement such that the engine-brake range is located below the drive range.

In another preferred embodiment of the present invention, a shift control method comprises determining if a current shift range is the engine-brake range, and down-shifting from a current shift speed to a shift speed lower by 1, if the current shift range is the engine-brake range. Preferably, the shift control method further comprises determining if the vehicle is running, and wherein said determining if a current shift range is the engine-brake range is performed only if it is determined that the vehicle is running.

It is preferable that the downshifting comprises determining if a current shift speed is greater than a first shift speed if it is determined that the current shift range is the engine-brake range, and down-shifting by 1 shift speed if it is determined that the current shift speed is greater than the first shift speed. Preferably, the shift speed is maintained to be a first shift speed if it is determined that the current shift speed is not greater than the first shift speed.

In a further preferred embodiment, the shift control method further comprises detecting an accelerator pedal position, and maintaining the current shift speed or outputting a signal for up-shifting, based on the detected accelerator pedal position. It is also preferable that the current shift speed be maintained if the accelerator pedal position is equal to 0 and the signal for up-shifting is output if the accelerator pedal position is smaller than a predetermined value.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 shows an arrangement of shift ranges according to the prior art;

FIG. 2 schematically shows an arrangement of shift ranges according to the preferred embodiment of the present invention;

FIG. 3 is a block diagram of the shift control system according to the preferred embodiment of the present invention; and

FIG. 4 is a flowchart showing the process of the shift control method according to the preferred embodiment of the present invention.

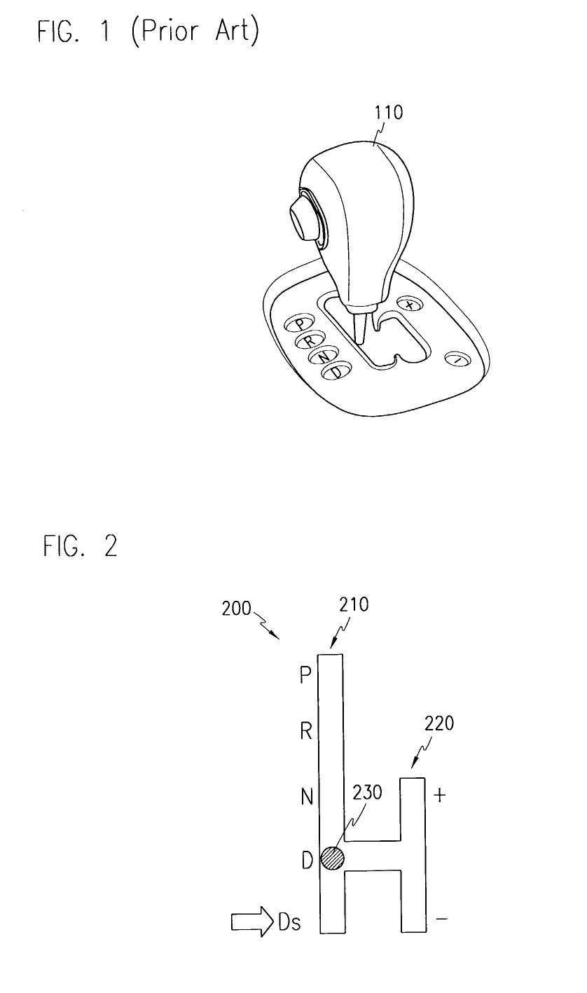

### DETAILED DESCRIPTION OF THE PREFERRED EMBODIMENTS

Hereinafter, a preferred embodiment of the present invention will be described in detail with reference to the accompanying drawings.

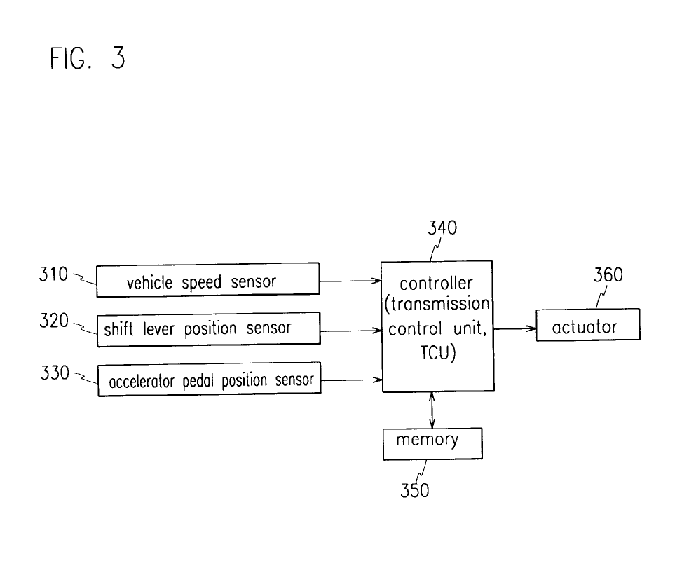

As shown in FIGS. 2 and 3, a shift control system according to a preferred embodiment of the present invention comprises a shift range assembly 200, a shift lever position sensor 320, an accelerator pedal position sensor 330, a controller(or a transmission control unit) 340, a memory 350, and an actuator 360.

The shift range assembly 200 comprises automatic shift mode ranges 210 and manual shift mode ranges 220. The automatic shift mode ranges 210 include a park P range, a reverse R range, a neutral N range, a drive D range, and an engine-brake Ds range, and the manual shift mode ranges 220 includes a manual shift-up (+) range and a manual shift-down (−) range. It is preferable that the Ds range is located below the drive D range, and if a shift lever 230 is located in the Ds range, a down-shift is performed such that the engine is used for braking. The P, R, N, and D ranges have the same functions as the conventional automatic transmission.

The shift lever position sensor 320 converts the position of the shift lever 230 into a corresponding electrical signal. That is, the shift lever position sensor 320 detects the shift range to which the shift lever is positioned and transfers the corresponding signal to the controller 340. As an example, only the shift lever position sensor 320 can be realized by an inhibitor switch.

The accelerator pedal position sensor 330 converts the accelerator pedal position into a corresponding electrical signal. That is, the accelerator pedal position sensor 330 detects the accelerator pedal position and transfers the corresponding signal to the controller 340.

The controller 340 performs general control of the shifting operation. More particularly, the controller 340 determines a target speed ratio on the basis of the signal from the shift lever position sensor 320 and the signal from the accelerator pedal position sensor 330, and it then outputs a corresponding shift signal to the actuator 360. Controller 340 may comprise a processor and associated hardware as may be selected and programmed by a person of ordinary skill in the art based on the teachings of the present invention.

The memory 350 stores a plurality of data and programs that are needed for the shift control, and the actuator 360 performs an up-shift or a down-shift according to the shift signal input from the controller 340. Memory 350 and controller 340 may communicate in accordance with conventional protocols.

A shift control system according to the present invention further comprises a vehicle speed sensor 310 for detecting vehicle speed. The vehicle speed sensor 310 preferably may comprise a pulse pick-up disposed near a gear assembly that is mounted to an output shaft of the transmission and rotates with the output shaft. In such an embodiment, when the gear assembly rotates, an alternate current is generated in the pulse pick-up. Preferably, the pulse pick-up is arranged in such a way that the frequency of the alternate current is proportional to an output shaft speed. The vehicle speed sensor 310 then converts the alternate current into a direct current and then inputs the converted direct current to the controller 340. Other suitable sensors may be devised by persons skilled in the art.

The shift control according to the present invention is preferably performed only when the vehicle is running. When the vehicle is running in the drive D range, the controller 340 determines an optimal target speed ratio in consideration of the vehicle speed.

If a driver moves the shift lever 230 to the engine-brake Ds range while the vehicle is running in the drive D range, the controller 340 performs a down-shift control SO that the engine is used for braking in all forward shift speeds excluding the lowest speed. For example, if a driver selects the engine-brake Ds range while the current shiftspeed is a third shift-speed, the target shift-speed is determined as a second shift-speed and a down-shift from the third speed ratio to the second speed ratio is then performed.

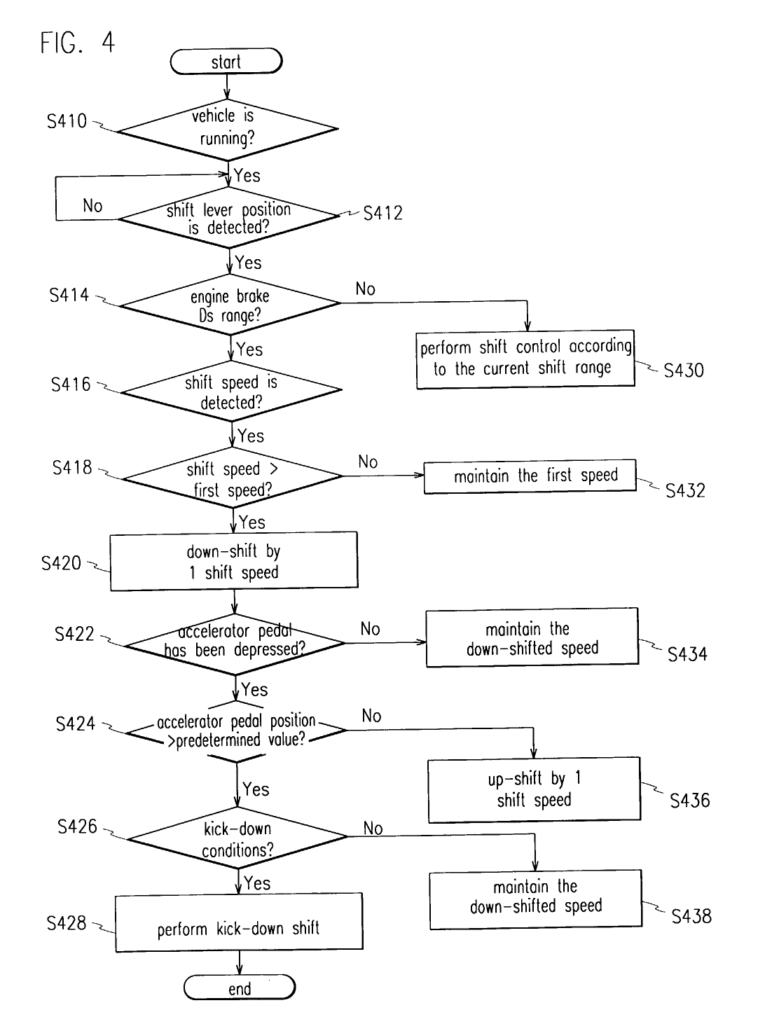

Referring to FIG. 4, a shift control method according to the preferred embodiment of the present invention will be explained.

The controller 340 determines whether the vehicle is running on the basis of the vehicle speed detected by the vehicle speed sensor 310 (S410). If it is determined that the vehicle is running in step S410, the controller 340 determines whether the current shift range is the engine brake Ds range on the basis of the signal input from the shift lever position sensor 320 (S412 and S414).

If it is determined that the current shift range is not the engine brake Ds range in step S414, the controller 340 performs shift control according to the current shift range (S430). On the other hand, if it is determined that the current shift range is the engine brake Ds range in step S414, the controller 340 determines whether the current shift speed is a first shift speed (S416 and S418).

If it is determined that the current shift speed is the first shift speed in step S418, the controller 340 maintains the current first shift speed (S432). On the other hand, if it is determined that the current shift speed is not the first shift speed in step S418, the controller 340 outputs a signal for down-shifting such that the shift speed decreases by 1 shift speed (S420).

After performing the down-shift, the controller 340 further determines the target shift speed on the basis of an accelerator pedal position. Thus, controller 340 determines if the accelerator pedal has been depressed (S422), and if it is not, the current down-shifted shift speed is maintained (S434). The reason for this is that not depressing the accelerator pedal can be considered as the driver having an intention to maintain the engine braking or an intention to slowly escape from a problematic situation. On the other hand, if it is determined that the accelerator pedal has been depressed in step S422, the controller 340 determines whether the accelerator pedal position is greater than a predetermined value stored in the memory 350 (S424).

If it is determined that the accelerator pedal position is not greater than the predetermined value in step S424, the controller 340 outputs a signal for up-sifting such that the shift speed increases by 1 shift speed (S436). Therefore, the shift speed returns to the shift speed of before the down-shift, because this can be considered as the driver intending to cancel the engine braking. On the other hand, if it is determined that the accelerator pedal position is greater than the predetermined value in step S424, the controller 340 determines if conditions for a kickdown shift exist (S426). Kickdown conditions may be determined based on the accelerator pedal position. For example, if the accelerator pedal position is greater than a predetermined value, it is determined that the kickdown condition exists.

If it is determined that the conditions for a kick-down shift do not exist in step S426, the down-shifted speed ratio is maintained (S438). The reason is that this can also be considered as the driver intending to maintain the engine braking or an intention to slowly escape from a problematic situation.

If it is determined that the kick-down conditions exist in step S426, the controller 340 performs a kick-down shift control (S428). That is, if the kick-down conditions exist, the controller 340 determines that the driver has an intention to urgently escape from a current situation, and therefore the kick-down shift is performed for rapid acceleration.

The shift control method according to the present invention is a shift control method in which a convenient down-shift is possible in every shift speed in order to use the engine for braking, even in an automatic transmission having a manual shift mode. Furthermore, engine braking can be used by a simple manipulation of the shift lever, and acceleration response can be increased when engine braking is no longer used.

What is claimed is:

1. A shift control system for an automatic transmission of a vehicle, said system comprising:
a shift range assembly for selecting a specific shift range of automatic shift mode ranges and manual shift mode ranges, said automatic shift mode ranges including a park range, a reverse range, a neutral range, a drive range, and an engine-brake range;
a shift lever position sensor for detecting the specific shift range selected by the shift lever assembly and outputting a corresponding signal; and
a shift controller for outputting a shift signal for down-shifting from a current shift speed to a shift speed lower by 1 shift speed, if the detected specific shift range is the engine-brake range.

2. The system of claim 1, wherein the automatic shift mode ranges are arranged with the engine-brake range located below the drive range.

3. A shift control method for an automatic transmission of a vehicle using a shift control system having a park range, a reverse range, a neutral range, a drive range, an engine-brake range, and a manual shift range for manually shifting the automatic transmission up and down, said method comprising:
determining if a current shift range is the engine-brake range; and
down-shifting from a current shift speed to a shift speed lower by 1, if the current shift range is the engine-brake range.

4. The method of claim 3, further comprising determining if the vehicle is running, and wherein said determining if a current shift range is the engine-brake range is performed only if it is determined that the vehicle is running.

5. The method of claim 3, wherein said down-shifting comprises:
determining if a current shift speed is greater than a first shift speed if it is determined that the current shift range is the engine-brake range; and
down-shifting by 1 shift speed if it is determined that the current shift speed is greater than the first shift speed.

6. The method of claim 5, wherein the shift speed is maintained to be a first shift speed if it is determined that the current shift speed is not greater than the first shift speed.

7. The method of claim 3, further comprising:
detecting an accelerator pedal position; and
maintaining the current shift speed or outputting a signal for up-shifting, based on the detected accelerator pedal position.

8. The method of claim 7, wherein the current shift speed is maintained if the accelerator pedal position has been depressed.

9. The method of claim 7, wherein the signal for up-shifting is output if the accelerator pedal position is smaller than a predetermined value.

10. The method of claim 9, further comprising:
determining if conditions for kickdown shift exist; and
outputting a signal for kickdown shift if it is determined that the conditions for kickdown shift exist.

11. The method of claim 10, wherein the current shift speed is maintained if it is determined that the conditions for kickdown shift do not exist.
